(19) United States
(12) Patent Application Publication
(10) Pub. No.: US 2018/0330865 A1
(43) Pub. Date: Nov. 15, 2018

(54) GAPPED RESONANT CURRENT TRANSFORMER

(71) Applicant: Standex International Corporation, Salem, NH (US)

(72) Inventor: Kehinde Omolayo, Cincinnati, OH (US)

(73) Assignee: Standex International Corporation, Salem, NH (US)

(21) Appl. No.: 15/977,247

(22) Filed: May 11, 2018

Related U.S. Application Data
(60) Provisional application No. 62/504,627, filed on May 11, 2017.

(51) Int. Cl. H01F 27/24; H01F 27/29; H01F 27/40

(52) U.S. Cl. CPC H01F 27/24; H01F 27/40; H01F 27/29

(57) ABSTRACT

A gapped resonant current transformer that has a pre-determined gap in a split-core. The invention eliminates the need for a magnetic flux shunt between the primary and secondary windings. Further, the sensitivity to the clamping force holding the two halves of the split-core is reduced as well as temperature effects on the core. Finally, excess heat is removed from overload (saturation) by circulating power back into the line.

This application claims benefit of U.S. Provisional Application Ser. No. 62/504,627 filed on May 11, 2017, pursuant to 35 USC § 119(e).

### FIELD OF THE INVENTION

This invention relates to current transformers, in particular, gapped resonant current transformers for power supply directly from a utility line grid.

### BACKGROUND OF THE INVENTION

The ferroresonant transformer or constant voltage transformer (ferro or CVT) has a very long history having been invented in 1938 by Joseph Sola and continuing to sell tens of thousands of units per year. The ferro of today has had some minor improvements but remains fundamentally unchanged from the original design.

Well known for its longevity, some CVTs are found still in service after more than 40 years. Limited to single phase applications, the ferro is slowly being displaced by small electronic voltage regulators.

The CVT uses the unique principle of ferroresonance: operation of a transformer in the region of magnetic saturation. When the core of a transformer is in saturation, relatively large changes in winding current results in very small changes in magnetic flux or induced voltage.

Current transformers are often used to monitor line currents for measurement purposes or to supply a small amount of power to external circuits for other electronic purposes. This external circuit or load, may contain a microprocessor or other electronic components. The output voltage from this transformer will be proportional to the input current. However, such external circuits can be damaged if the line current supplying the power is too high.

Previous devices have placed a separate circuit between the transformer output and the load to limit the amount of voltage passed on to the critical load circuit. This limiting circuit adds cost and can reduce the efficiency of the device, consuming the rather limited amount of power usually available from the current transformer. Addition of a gap in the core will allow control of the magnetic flux harmonic in the core and, thus, limit the transformer noise level. However, this reduces the coil inductance and magnetic coupling factor of the current transformer.

Other prior designs use a ferroresonant transformer for voltage regulation. A ferroresonant transformer has a magnetic shunt that separates the primary and secondary (load and capacitor) magnetic flux during saturation; whereas, the construction of this invention is relatively simple. It's a toroid core having a load winding and a second winding with a capacitor. The invention does not require the magnetic flux shunt between the primary and secondary windings.

### SUMMARY OF THE INVENTION

It is an aspect of the invention to provide a resonant current transformer having a gapped split-core that reduces the sensitivity of the installation clamping force on the split core on the power output.

Another aspect of the invention is to provide a resonant current transformer having a gapped split-core that reduces the sensitivity of the interface between the two halves of the core relative to the finish and flatness of the mating surfaces which is hard to maintain during the manufacture and control during field installation.

It is an aspect of the invention to provide a resonant current transformer having a gapped split-core that substantially reduces the effect of temperature on the core saturation point.

It is an aspect of the invention to provide a resonant current transformer having a gapped split-core that reduces the sensitivity of the power output to environmental corrosion conditions.

Another aspect of the invention is to provide a resonant current transformer having a gapped split core that removes excess heat from overload (saturation) conditions by circulating power back into the line.

Finally, it is still another aspect of the invention to provide a resonant current transformer having a gapped split-core that eliminates the need for a solid-state crowbar circuit thereby substantively reducing additional cost and electrical or audible noise in the system due to device switching characteristics.

### BRIEF DESCRIPTION OF THE DRAWINGS

FIG. 1 is an illustration of the prior art.

FIG. 2 is an illustration of resonant current transformer having a gapped split-core in accordance with the invention.

### DETAILED DESCRIPTION OF THE INVENTION

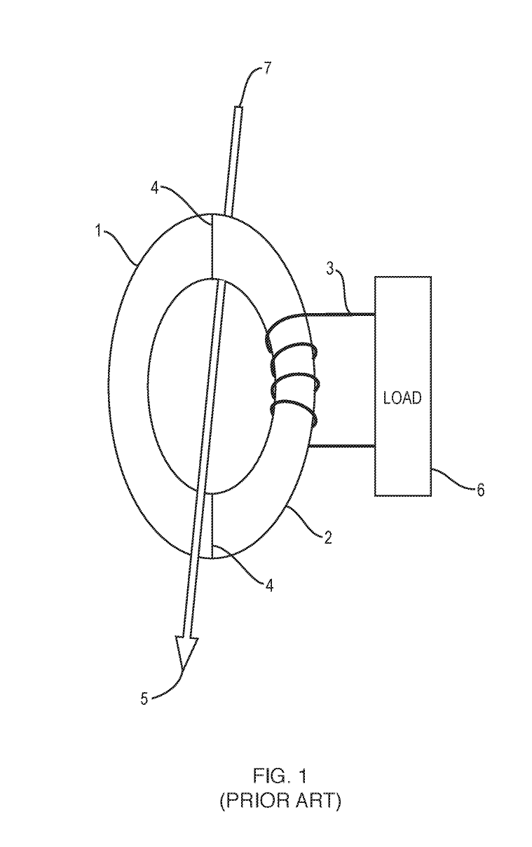

Now referring to FIG. 1, this is an illustration of the prior art having a current transformer with a winding used to supply a small amount of power to a load. Toroid core 1 is cut into two halves 1 & 2 forming interfaces 4's. Bus wire 7 conducting line current 5 causes a magnetic flux to be generated in the core. Load winding 3 coupled to this magnetic flux provides voltage to output load 6.

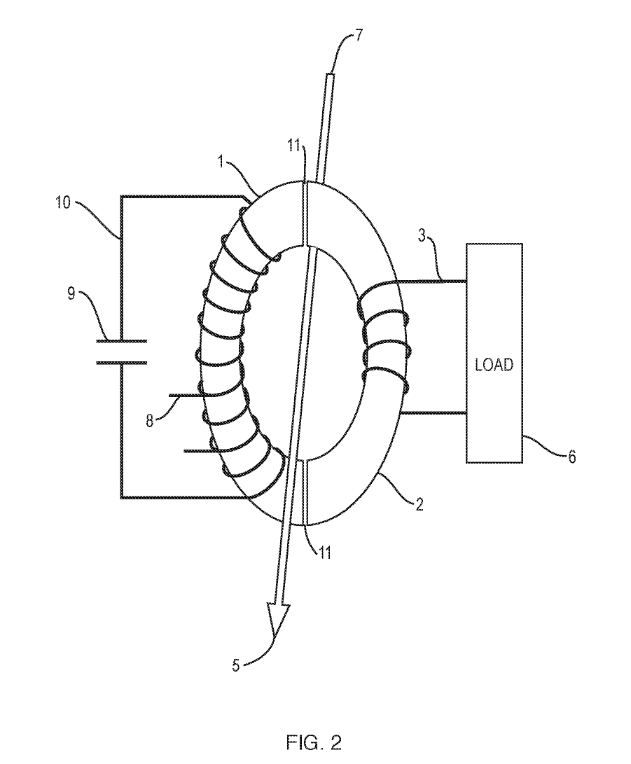

As shown in FIG. 2, there is an illustration of the present invention. This invention uses toroid core 1 cut in two halves where a nonmagnetic material 11 (such as parylene, paint, tape, etc.) of known thickness is placed in the two gaps to protect the core interfaces from environmental corrosion. Bus wire 7 conducting line current 5 causing a magnetic flux to be generated in the core. Winding 3 coupled to this magnetic flux provides voltage to load 6. Added to this core and coupled to the magnetic flux is an auxiliary winding 10 of higher turn count. This winding is connected to a capacitor 9 to form a circuit resonate at the line frequency. FIG. 2 also shows taps 8 which allow selection during manufacturing of the best match between the line frequency and the circuit self-resonant frequency. This optimum match improves the maximum output power over the prior art.

High voltage spikes may be destructive to the output load with a prior art device. Voltage slow rate of change across the invention capacitor 9 of FIG. 2 suppresses the voltage spikes or peeks.

Although the present invention has been described with reference to certain preferred embodiments thereof, other versions are readily apparent to those of ordinary skill in the preferred embodiments contained herein.

What is claimed is:

1. A resonant current transformer comprising: a toroid core cut into two substantially identical halves wherein said two halves are clamped together to form a pre-determined gapped split-core such that said pre-determined gapped split-core having an installation clamping force requirement wherein the sensitivity of the installation clamping force on the split-core on the power output is reduced and, wherein the effect of temperature on the core saturation point is also substantially reduced.

2. The resonant current transformer of claim 1 wherein said pre-determined gap of the split-core is filled with a nonmagnetic material.

3. The resonant current transformer of claim 2 wherein said nonmagnetic material placed within said gap is parylene.

4. The resonant current transformer of claim 2 wherein said nonmagnetic material placed within said gap is paint.

5. The resonant current transformer of claim 2 wherein said nonmagnetic material placed within said gap is tape.

6. The resonant current transformer of claim 2 wherein said nonmagnetic material placed within said gap protects the core interfaces from environmental corrosion.

7. The resonant current transformer of claim 2 further comprising a bus wire conducting a line current through said core causing a magnetic flux to be generated therein.

8. The resonant current transformer of claim 7 further comprising a first winding to said core that enables said magnetic flux to provide a voltage to a load.

9. The resonant current transformer of claim 8 further comprising a second winding on said core wherein said second winding has a capacitor to provide a resonate circuit at the line frequency.

10. The resonant current transformer of claim 9 further comprising at least one tap on said second winding permitting the best match between line frequency and the resonate circuit to provide the maximum output power.
